(19) United States
(12) Patent Application Publication
(10) Pub. No.: US 2026/0036735 A1
(43) Pub. Date: Feb. 5, 2026

(54) Optical Waveguide Structure and AR Display Device

(71) Applicant: Sunny Omnilight Technology Co., Ltd., Yuyao (CN)

(72) Inventors: Zhiming CHENG, Yuyao (CN); Cong WANG, Yuyao (CN); Wei ZHANG, Yuyao (CN); Jian LOU, Yuyao (CN); Yusheng MING, Yuyao (CN); Jie WANG, Yuyao (CN); Yuan CHEN, Yuyao (CN)

(73) Assignee: Sunny Omnilight Technology Co., Ltd., Yuyao (CN)

(21) Appl. No.: 18/971,936

(22) Filed: Dec. 6, 2024

(30) Foreign Application Priority Data
Aug. 2, 2024 (CN) 202411060480.0

(51) Int. Cl. F21V 8/00; G02B 27/00; G02B 27/01; G02B 27/10

(52) U.S. Cl. CPC G02B 6/0016; G02B 6/0036; G02B 27/0081; G02B 27/0103; G02B 27/102

(57) ABSTRACT

The disclosure provides an optical waveguide structure and an AR display device. The optical waveguide structure includes: a waveguide substrate; a coupling-in area, the coupling-in area is arranged on the waveguide substrate; a plurality of diffraction grating areas, two side surfaces of the waveguide substrate are provided with the diffraction grating areas, a number of the diffraction grating areas on at least one side surface of the waveguide substrate is greater than or equal to 2, periods of the diffraction grating areas are equal, and the diffraction grating areas are configured to perform multiple pupil expansions on a light; and a coupling-out area, the coupling-out area is arranged on the waveguide substrate, the diffraction grating areas are all located between the coupling-in area and the coupling-out area, and the coupling-out area is configured to perform pupil expansion transmission on a light in the waveguide substrate and emit the light.

### CROSS-REFERENCE TO RELATED APPLICATION(S)

The disclosure claims the priority to Chinese Patent Application No. 202411060480.0, filed with the China National Intellectual Property Administration (CNIPA) on Aug. 2, 2024, which is hereby incorporated by reference in its entirety.

### FIELD

The disclosure relates to the technical field of optical devices, and in particular to an optical waveguide structure and an AR display device.

### BACKGROUND

As an augmented reality (AR) technology continuously develops, various types of AR display devices have gradually emerged in people's lives. For example, AR glasses are typically equipped with an optical waveguide structure to display an image. Current solutions of the optical waveguide structure mainly include surface relief, volume holography and array waveguide. The surface relief and the volume holography are both based on physical optics. Different wavelengths of light will be dispersed during diffraction, resulting in asynchronous propagation of different wavelengths in an optical waveguide in the same field of view, and accordingly an efficiency difference of different wavelengths is introduced in a subsequent process of light propagation. That is, inconsistent transmission efficiency of different wavelengths is generated, and is reflected as color deviation in a finally coupled optical field. The array waveguide is based on a principle of a geometric ray, and mainly uses a light transmission process including reflection, total reflection or partial reflection, and partial transmission without dispersion. Although its uniformity is superior to that of the solutions of the surface relief and the volume holography, its diffraction efficiency is poor.

In other words, it is difficult to simultaneously balance the color uniformity and the diffraction efficiency of the optical waveguide structure in the related art.

### SUMMARY

A main objective of the disclosure is to provide an optical waveguide structure and an AR display device, so as to solve the problem that it is difficult to simultaneously balance color uniformity and diffraction efficiency of an optical waveguide structure in the related art.

In order to achieve the above objective, some embodiments of the disclosure provide an optical waveguide structure, including: a waveguide substrate; a coupling-in area, where the coupling-in area is arranged on the waveguide substrate; a diffraction grating area, where a plurality of diffraction grating areas are provided, two side surfaces of the waveguide substrate are provided with the diffraction grating area, and a number of the diffraction grating areas on at least one side surface of the waveguide substrate is greater than or equal to 2, periods of the plurality of diffraction grating areas are equal, and the plurality of diffraction grating areas are configured to perform multiple pupil expansion transmissions on a light; and a coupling-out area, where the coupling-out area is arranged on the waveguide substrate, the plurality of diffraction grating areas are all located between the coupling-in area and the coupling-out area, and the coupling-out area is configured to perform pupil expansion transmission on a light in the waveguide substrate and emit the light.

In some embodiments, the plurality of diffraction grating areas include a first diffraction grating area, a second diffraction grating area and a third diffraction grating area, the first diffraction grating area and the second diffraction grating area are located on one side surface of the waveguide substrate, the third diffraction grating area is located on the other side surface of the waveguide substrate, the first diffraction grating area is configured to receive a light of the coupling-in area and perform a first pupil expansion, and the second diffraction grating area and the third diffraction grating area are configured to receive a light of the first diffraction grating area and perform a second pupil expansion.

In some embodiments, the first diffraction grating area and the second diffraction grating area are arranged continuously or arranged in a spaced manner, the second diffraction grating area is the same as the third diffraction grating area, and a projection of the second diffraction grating area on the waveguide substrate at least partially coincides with a projection of the third diffraction grating area on the waveguide substrate; and/or the first diffraction grating area performs the first pupil expansion on the light, the second diffraction grating area performs the second pupil expansion on the light, the third diffraction grating area performs a third pupil expansion on the light, a pupil expansion propagation direction of the light on the first diffraction grating area is the same as a pupil expansion propagation direction of the light on the third diffraction grating area, and the pupil expansion propagation direction of the light on the first diffraction grating area is different from a pupil expansion propagation direction of the light on the second diffraction grating area.

In some embodiments, periods of the first diffraction grating area, the second diffraction grating area and the third diffraction grating area are equal; and/or included angles between grating vector directions of the first diffraction grating area, the second diffraction grating area and the third diffraction grating area on a k-domain diagram and a y-axis are equal.

In some embodiments, grating vectors of the first diffraction grating area, the second diffraction grating area and the third diffraction grating area are equal in magnitude; and/or a grating vector direction of the second diffraction grating area is the same as a grating vector direction of the third diffraction grating area, and a grating vector direction of the first diffraction grating area is opposite to the grating vector direction of the second diffraction grating area.

In some embodiments, a 0th-order diffraction efficiency R0 of the first diffraction grating area satisfies: 5%<R₀<60%, and a +1st-order or −1st-order diffraction efficiency R1 of the first diffraction grating area satisfies: 40%<R₁<95%; and/or a 0th-order diffraction efficiency R0 of the second diffraction grating area satisfies: 10% <R₀<95%, and a +1st-order or −1st-order diffraction efficiency R1 of the second diffraction grating area satisfies: 5%<R₁<80%.

In some embodiments, at least one of the first diffraction grating area, the second diffraction grating area and the third diffraction grating area is divided into a plurality of blocks, at least one of a vector height and a duty ratio of each of the plurality of blocks is regularly changed, and when one of the vector height and the duty ratio is regularly changed, the other one of the vector height and the duty ratio is a fixed value.

In some embodiments, the plurality of diffraction grating areas include one or more of surface relief gratings and volume holographic gratings.

In some embodiments, the coupling-in area includes one of a reflective surface and a prism, where when the coupling-in area includes the reflective surface, the reflective surface is located at a side surface of the waveguide substrate, the waveguide substrate has a first surface and a second surface arranged opposite each other, the reflective surface is arranged at an acute angle relative to one of the first surface and the second surface, and an included angle θᵢₙ between the reflective surface and the first surface or the second surface satisfies:

$${θ}_{in} > 1 / 2 \cdot [ a sin ( sin {θ}_{H} / {n}_{wg} ) + a sin ( 1 / {n}_{wg} ) ] ;$$

wherein n_{wg} is a refractive index of the waveguide substrate, θ_{H}=atan[tan D_{θ}/\sqrt{1+1/k²}], D_{θ} is a field of view of an optical machine, and k is an aspect ratio of a projection screen of the optical machine.

In some embodiments, the coupling-out area includes a plurality of light splitting layers, where the plurality of light splitting layers are arrayed in the waveguide substrate, the plurality of light splitting layers are located at one sides of the diffraction grating areas away from the coupling-in area, the waveguide substrate has a first surface and a second surface arranged opposite each other, and each of the plurality of light splitting layers is obliquely arranged to the first surface and the second surface, and a number of the light splitting layers is greater than or equal to 3 and less than or equal to 10; and/or a reflectivity of each of the plurality of light splitting layers is greater than 5% and less than or equal to 55%; and/or an included angle between each of the plurality of light splitting layers and the second surface is equal to an included angle between a reflective surface of the coupling-in area and the second surface.

Some other embodiments of the disclosure provide an AR display device, including: an optical machine; and the optical waveguide structure, where the optical machine is configured to emit image light to the optical waveguide structure.

The technical solution of the disclosure is applied, and the optical waveguide structure includes the waveguide substrate, the diffraction grating area and the coupling-out area. The coupling-in area is arranged on the waveguide substrate; the plurality of diffraction grating areas are provided, two side surfaces of the waveguide substrate are provided with the diffraction grating area, the number of the diffraction grating areas on at least one side surface of the waveguide substrate is greater than or equal to 2, the periods of the plurality of diffraction grating areas are equal, and the plurality of diffraction grating areas are configured to perform multiple pupil expansions on the light; and the coupling-out area is arranged on the waveguide substrate, the plurality of diffraction grating areas are all located between the coupling-in area and the coupling-out area, and the coupling-out area is configured to perform pupil expansion transmission on the light in the waveguide substrate and emit the light.

The coupling-in area is configured to guide the light emitted by the external optical machine into the waveguide substrate and transmit the light in the waveguide substrate, so as to further transmit the light to the plurality of diffraction grating areas, and the plurality of diffraction grating areas receive the light transmitted from the coupling-in area and perform multiple pupil expansion transmissions on the light; positions of the plurality of diffraction grating areas are reasonably planned, such that two side surfaces of the waveguide substrate are provided with the diffraction grating area, and the plurality of diffraction grating areas are provided on at least one side surface of the waveguide substrate; the periods of the diffraction grating areas are further planned to be equal such that the plurality of diffraction grating areas on the two surfaces are able to perform sufficient pupil expansion on the light in the waveguide substrate, thereby reducing a total reflection step of the light in the waveguide substrate, increasing a density of the field of view after pupil expansion to avoid light-pupil separation, further improving diffraction efficiency, and improving color uniformity and illumination uniformity of a coupled image.

### BRIEF DESCRIPTION OF DRAWINGS

The accompanying drawings of the description, which form a part of the disclosure, are used to provide further understanding of the disclosure, and illustrative embodiments of the disclosure and their description are used to explain the disclosure and are not intended to unduly limit the disclosure. In the figures:

FIG. 1 shows a k-domain diagram of an optical waveguide structure of Embodiment 1 of the disclosure;

FIG. 2 shows a schematic diagram of one side of an optical waveguide structure of Embodiment 1 of the disclosure;

FIG. 3 shows a schematic diagram of the other side of an optical waveguide structure of Embodiment 1 of the disclosure;

FIG. 4 shows a pupil expansion optical path diagram of the optical waveguide structure in FIG. 2;

FIGS. 5-6 show optical path diagrams of the optical waveguide structure with and without a third diffraction grating area of Embodiment 1 of the disclosure respectively;

FIG. 7 shows a schematic diagram of path energy after a first-order diffraction in a first diffraction grating area of an optical waveguide structure of Embodiment 1 of the disclosure;

FIG. 8 shows a schematic diagram of path energy after a second-order diffraction in a first diffraction grating area of an optical waveguide structure of Embodiment 1 of the disclosure;

FIG. 9 shows a schematic diagram of efficiency distribution of a first diffraction grating area for regulating a large-wavelength light of an optical waveguide structure of Embodiment 1 of the disclosure;

FIG. 10 shows a schematic diagram of efficiency distribution of a first diffraction grating area for regulating a small-wavelength light of an optical waveguide structure of Embodiment 1 of the disclosure;

FIG. 11 shows a schematic diagram of path energy after a second-order diffraction in a first diffraction grating area for regulating a large-wavelength light and small-wavelength light of an optical waveguide structure of Embodiment 1 of the disclosure;

FIG. 12 shows a schematic structural diagram of an optical waveguide structure of Embodiment 1 of the disclosure;

FIG. 13 shows a cross-sectional view of FIG. 12 in an A-A direction;

FIGS. 14-15 show enlarged views of portions B and C in FIG. 13 respectively;

FIG. 16 shows a k-domain diagram of an optical waveguide structure of Embodiment 2 of the disclosure;

FIG. 17 shows a schematic structural diagram of an optical waveguide structure of Embodiment 2 of the disclosure;

FIG. 18 shows a k-domain diagram of an optical waveguide structure of Embodiment 3 of the disclosure;

FIG. 19 shows a schematic structural diagram of an optical waveguide structure of Embodiment 3 of the disclosure; and

FIG. 20 shows a structural comparison diagram of an optical waveguide structure of Embodiment 3 and Embodiment 1 of the disclosure.

The figures include the following reference numerals:

10, waveguide substrate; 11, first surface; 12, second surface; 21, reflective surface; 31, first diffraction grating area; 32, second diffraction grating area; 33, third diffraction grating area; 40, coupling-out area; and 41, light splitting layer.

### DESCRIPTION OF EMBODIMENTS

It should be noted that the embodiments in the disclosure and the features in the embodiments can be combined with one another on the premise of no conflict. The disclosure will be described in detail below with reference to the accompanying drawings and in combination with the embodiments.

It should be noted that all technical and scientific terms used in the disclosure have the same meanings as commonly understood by those of ordinary skill in the technical field to which the disclosure belongs unless otherwise indicated.

In the disclosure, directional words used, such as “upper, lower, top and bottom”, are usually for the direction shown in the accompanying drawings, or for the component itself in the upright, vertical, or gravity direction, unless otherwise stated to the contrary; and similarly, for the convenience of understanding and description, “inside and outside” refers to the inside and outside relative to the contour of each component itself, but the above directional words are not intended to limit the disclosure.

In order to solve the problem that it is difficult to simultaneously balance color uniformity and diffraction efficiency of an optical waveguide structure in the related art, the disclosure provides an optical waveguide structure and an AR display device.

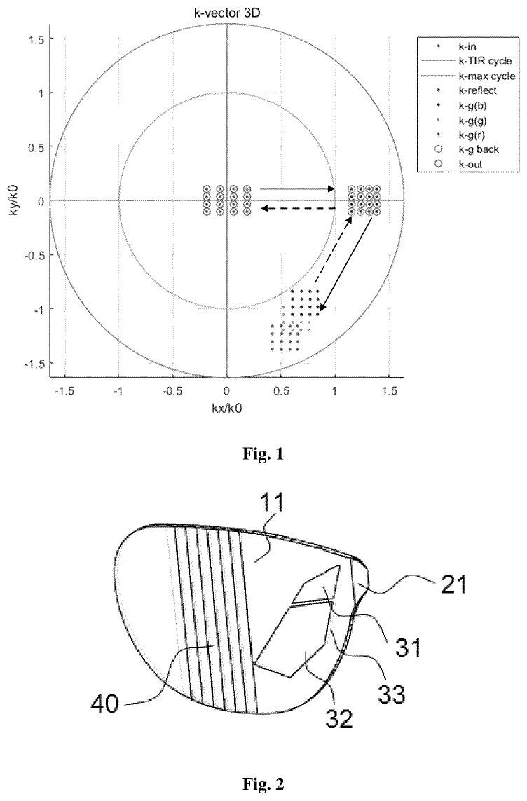

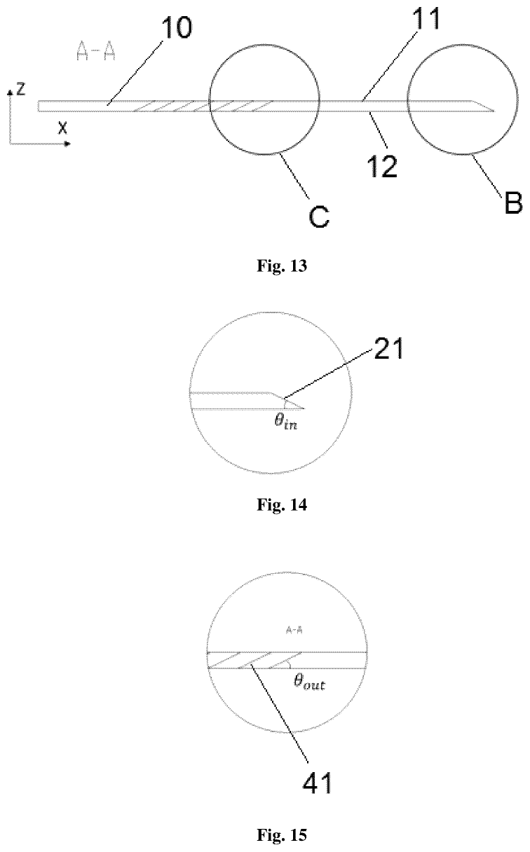

As shown in FIGS. 1-20, the optical waveguide structure includes a waveguide substrate 10, a diffraction grating area and a coupling-out area 40. The coupling-in area is arranged on the waveguide substrate 10; a plurality of diffraction grating areas are provided, two side surfaces of the waveguide substrate 10 are provided with the diffraction grating area, a number of the diffraction grating areas on at least one side surface of the waveguide substrate 10 is greater than or equal to 2, periods of the plurality of diffraction grating areas are equal, and the plurality of diffraction grating areas are configured to perform multiple pupil expansions on a light; and the coupling-out area 40 is arranged on the waveguide substrate 10, the plurality of diffraction grating areas are all located between the coupling-in area and the coupling-out area 40, and the coupling-out area 40 is configured to perform pupil expansion transmission on a light in the waveguide substrate 10 and emit the light.

The coupling-in area is configured to guide the light emitted by the external optical machine into the waveguide substrate 10 and transmit the light in the waveguide substrate 10, so as to further transmit the light to the plurality of diffraction grating areas, and the plurality of diffraction grating areas receive the light transmitted from the coupling-in area and perform multiple pupil expansion transmissions; positions of the plurality of diffraction grating areas are reasonably planned, such that two side surfaces of the waveguide substrate 10 are provided with the diffraction grating area, and the plurality of diffraction grating areas are provided on at least one side surface of the waveguide substrate; the periods of the diffraction grating areas are further planned to be equal such that the diffraction grating areas on the two surfaces are able to perform sufficient pupil expansion on the light in the waveguide substrate 10, thereby reducing a total reflection step of the light in the waveguide substrate 10, increasing a density of a field of view (FOV) after pupil expansion to avoid light-pupil separation, further improving diffraction efficiency, and improving color uniformity and illumination uniformity of a coupled-out image.

It should be noted that both the coupling-in area and the coupling-out area 40 are geometric structures, and the light is transmitted according to principles of reflection, total reflection and light splitting. The diffraction grating area is able to diffract the light. By selecting the geometric structures as the coupling-in area and the coupling-out area 40, light leakage and dispersion of a diffraction structure are avoided, coupling-in efficiency and coupling-out efficiency are improved to avoid light loss, and diffraction efficiency of an overall optical waveguide structure is further improved.

In an embodiment of the disclosure, the plurality of diffraction grating areas include a first diffraction grating area 31, a second diffraction grating area 32 and a third diffraction grating area 33. The first diffraction grating area 31 and the second diffraction grating area 32 are located on one side surface of the waveguide substrate 10, the third diffraction grating area 33 is located on the other side surface of the waveguide substrate 10, the first diffraction grating area 31 is configured to receive a light of the coupling-in area and perform a first pupil expansion, and the second diffraction grating area 32 and the third diffraction grating area are configured to receive a light of the first diffraction grating area 31 and perform a second pupil expansion. Specifically, the waveguide substrate 10 has a first surface 11 and a second surface 12 arranged opposite each other, the first diffraction grating area 31 and the second diffraction grating area 32 are arranged continuously or arranged on the first surface 11 in a spaced manner, the third diffraction grating area 33 is arranged on the second surface 12, and a projection of the second diffraction grating area 32 on the waveguide substrate 10 at least partially coincides with a projection of the third diffraction grating area 33 on the waveguide substrate 10. By additionally arranging the third diffraction grating area 33, the third diffraction grating area 33 is able to regulate distribution of diffraction efficiency of different wavelengths by means of multiple diffraction, so as to achieve the first pupil expansion and simultaneously improve color deviation introduced by diffraction in the optical waveguide structure. Thus, a third pupil expansion is achieved by means of the coupling-out area 40. The optical waveguide structure of the disclosure integrates the geometric structures and diffraction gratings, and is able to achieve two-dimensional pupil expansion having high efficiency, low color deviation and low light leakage.

In an embodiment of the disclosure, the projection of the second diffraction grating area 32 on the waveguide substrate 10 completely coincides with the projection of the third diffraction grating area 33 on the waveguide substrate 10, a projection area of the second diffraction grating area 32 on the waveguide substrate 10 is greater than a projection area of the first diffraction grating area 31 on the waveguide substrate 10, and the projection area of the second diffraction grating area 32 on the waveguide substrate 10 is equal to a projection area of the third diffraction grating area 33 on the waveguide substrate 10.

In the embodiment, the second diffraction grating area 32 and the third diffraction grating area 33 have the same structure and parameters. Specifically, a grating line direction of the second diffraction grating area 32 is the same as a grating line direction of the third diffraction grating area 33, a vector magnitude of the second diffraction grating area 32 is the same as a vector magnitude of the third diffraction grating area 33, and a grating period of the second diffraction grating area 32 is the same as a grating period of the third diffraction grating area 33. In this way, it is beneficial for the second diffraction grating area 32 and the third diffraction grating area 33 to receive light from the first diffraction grating area 31, so as to ensure that the second pupil expansion is more sufficient, and at the same time, it is beneficial for the third diffraction grating area 33 to regulate the distribution of the diffraction efficiency of different wavelengths by means of multiple diffraction, thereby improving a color deviation introduced by diffraction and increasing a color uniformity. In an embodiment, the second diffraction grating area 32 and the third diffraction grating area 33 are the same, and further include the same duty ratio and the same height.

In an embodiment of the disclosure, the first diffraction grating area 31 performs the first pupil expansion on the light, the second diffraction grating area 32 performs the second pupil expansion on the light, and the third diffraction grating area 33 performs the third pupil expansion on the light. A pupil expansion propagation direction of the light on the first diffraction grating area 31 is the same as a pupil expansion propagation direction of the light on the third diffraction grating area 33, and the pupil expansion propagation direction of the light on the first diffraction grating area 31 is different from a pupil expansion propagation direction of the light on the second diffraction grating area 32. That is, the first pupil expansion is completed while the light propagates forwards in the first diffraction grating area 31, the second pupil expansion is completed while the light propagates forwards in the second diffraction grating area 32, and the third pupil expansion is completed while the light propagates forwards in the third diffraction grating area 33. A propagation direction of the light in the first diffraction grating area 31 is the same as a propagation direction of the light in the third diffraction grating area 33, the propagation direction of the light in the first diffraction grating area 31 is different from a propagation direction of the light in the second diffraction grating area 32, and the propagation direction of the light in the third diffraction grating area 33 is different from the propagation direction of the light in the second diffraction grating area 32. In this way, an overall efficiency difference of different wavelengths in the same field of view is effectively improved, and color and illumination uniformity of a coupled optical field are improved.

In an embodiment of the disclosure, periods of the first diffraction grating area 31, the second diffraction grating area 32 and the third diffraction grating area 33 are equal. In this way, it is beneficial to ensure a stability of pupil expansion transmission and high diffraction efficiency.

In an embodiment of the disclosure, referring to FIG. 1, included angles between grating vector directions of the first diffraction grating area 31, the second diffraction grating area 32 and the third diffraction grating area 33 on a k-domain diagram and a y-axis are equal. Specifically, an included angle between a grating vector direction of the first diffraction grating area 31 on the k-domain diagram and the y-axis, an included angle between a grating vector direction of the second diffraction grating area 32 on the k-domain diagram and the y-axis, and an included angle between a grating vector direction of the third diffraction grating area 33 on the k-domain diagram and the y-axis are equal. In this way, it is beneficial for a diffraction principle of the three diffraction grating areas to match a requirement of a k-domain closed loop, and a transmission path of the light in the waveguide substrate 10 is planned to avoid light loss and ensure diffraction efficiency.

In the embodiment, referring to FIG. 1, grating vectors of the first diffraction grating area 31, the second diffraction grating area 32 and the third diffraction grating area 33 are equal in magnitude. Thus, the k-domain closed loop is ensured. The grating vector direction of the second diffraction grating area 32 is the same as the grating vector direction of the third diffraction grating area 33, so as to ensure that the second diffraction grating area 32 and the third diffraction grating area 33 are able to simultaneously achieve the second pupil expansion, and ensure that light after pupil expansion is able to be stably transmitted to the coupling-out area 40, thereby ensuring diffraction transmission reliability. The grating vector direction of the first diffraction grating area 31 is opposite to the grating vector direction of the second diffraction grating area 32, and the grating vector direction of the first diffraction grating area 31 is opposite to the grating vector direction of the third diffraction grating area 33. In this way, it is ensured that diffraction dispersion of gratings is compensated to 0, thereby ensuring the k-domain closed loop.

In an embodiment of the disclosure, the plurality of diffraction grating areas include one or more of surface relief gratings and volume holographic gratings. A grating in the volume holographic grating is a structure having a graded refractive index to achieve a diffraction function. The plurality of diffraction grating areas are all one-dimensional grating structures, and the three diffraction grating areas match each other and have two directions of pupil expansion such that the optical waveguide structure is able to achieve two-dimensional pupil expansion and ensure uniformity of final color display and illumination uniformity. At least one of the first diffraction grating area 31, the second diffraction grating area 32 and the third diffraction grating area 33 is divided into a plurality of blocks, at least one of a vector height and a duty ratio of each of the plurality of blocks is regularly changed, and when one of the vector height and the duty ratio is regularly changed, the other one of the vector height and the duty ratio is a fixed value. The grating area is divided into the plurality of blocks and the duty ratios or the vector heights of different blocks are modulated, such that it is ensured that the first pupil expansion is completed while the grating area is able to achieve turning, diffraction dispersion is compensated in a subsequent propagation process, and colors of a finally coupled optical field of the waveguide substrate 10 are distributed more uniformly; and by means of a configuration of the plurality of blocks, illumination and color uniformity of the coupled optical field are able to be modulated by modulating diffraction efficiency of different orders of the plurality of blocks, such that color uniformity of the coupled optical field is better.

In the embodiment, the first diffraction grating area 31 is a surface relief grating or a volume holographic grating. In an embodiment of the disclosure, the first diffraction grating area 31 is integrally arranged. In another embodiment of the disclosure, the first diffraction grating area 31 is divided into the plurality of blocks, one of a vector height and a duty ratio of each of the plurality of blocks is regularly changed, and the other one of the vector height and the duty ratio is a fixed value. When the vector heights of the plurality of blocks are regularly changed, the vector heights of the plurality of blocks are different, and are gradually increased or reduced along a diffraction transmission path. When the duty ratios of the plurality of blocks are regularly changed, the duty ratios of the plurality of blocks are different, and are gradually increased or reduced along the diffraction transmission path. When a light beam irradiates the first diffraction grating area 31, +1st-order and 0th-order light beams or −1st-order and 0th-order light beams are diffracted. The +1st-order or −1st-order light beam propagates towards directions of the second diffraction grating area 32 and the third diffraction grating area 33, the 0th-order light beam continues propagating by total reflection in the waveguide substrate 10 while keeping a propagation direction unchanged, +1st-order and Oth-order light beams or −1st-order and 0th-order light beams continue being diffracted when the light beam makes contact with the first diffraction grating area 31 next time, and the first pupil expansion is completed after multiple diffraction. A zero-order diffraction fringe is improved by means of such a configuration.

In the embodiment, a 0th-order diffraction efficiency R₀ of the first diffraction grating area 31 satisfies: 5%<R₀<60%, and a +1st-order or −1st-order diffraction efficiency R₁ of the first diffraction grating area satisfies: 40%<R₁<95%. The first diffraction grating area 31 is divided into the plurality of blocks, and the vector height or the duty ratio of each block is modulated, such that distribution of diffraction efficiency ratios of different small blocks is able to reduce color deviation caused by differences in a total reflection step and diffraction efficiency of different wavelengths in subsequent propagation. Small blocks contacted by the light at first have high 0th-order efficiency and low +1st-order or −1st-order diffraction efficiency for a large-wavelength spectrum, and have opposite efficiency for a short-wavelength spectrum, so as to improve a spatial energy coincidence of a transmission path of different wavelengths in a next grating area.

It should be noted that when the first diffraction grating area 31 is divided into the plurality of blocks, the plurality of blocks are arrayed in a grid manner, or the first diffraction grating area is divided into the plurality of blocks in a light transmission direction of a coupling-in area, and each block matches light of different wavelength ranges.

In the embodiment, the second diffraction grating area 32 is the surface relief grating or the volume holographic grating. In an embodiment of the disclosure, the second diffraction grating area 32 is integrally arranged. In another embodiment of the disclosure, the second diffraction grating area 32 is divided into the plurality of blocks, one of a vector height and a duty ratio of each of the plurality of blocks is regularly changed, and the other one of the vector height and the duty ratio is a fixed value. When the vector heights of the plurality of blocks are regularly changed, the vector heights of the plurality of blocks are different, and are gradually increased or reduced along a diffraction transmission path. When the duty ratios of the plurality of blocks are regularly changed, the duty ratios of the blocks are different, and are gradually increased or reduced along the diffraction transmission path. After a light beam makes contact with a block, −1 st-order and 0th-order light beams or +1st-order and Oth-order light beams are diffracted. The −1st-order light beam or the +1st-order light beam is turned to a coupling-out area 40, the 0th-order light beam keeps an original direction and continues propagating until the light beam makes contact with a next block, and the light beam continues being split and turned in the next block to complete the second pupil expansion. A 0th-order diffraction efficiency R₀ of the second diffraction grating area 32 satisfies: 10%<R₀<95%, and a +1st-order or −1st-order diffraction efficiency R₁ of the second diffraction grating area satisfies: 5%<R₁<80%. In this way, the second diffraction grating area 32 receives an optical field turned by the first diffraction grating area 31, and turns the optical field to the coupling-out area 40, and the second pupil expansion is achieved in the process; a diffraction order efficiency of each block is able to be separately set by modulating the duty ratio or the vector height, thereby modulating color and illumination distribution of the optical field, and ensuring color uniformity of a coupled optical field. It should be noted that when the second diffraction grating area 32 is divided into the plurality of blocks, the plurality of blocks are arrayed in a grid manner, or the second diffraction grating area is divided into the plurality of blocks along a light transmission direction perpendicular to the first diffraction grating area 31, and each block matches light of different wavelength ranges.

In the embodiment, the third diffraction grating area 33 is the surface relief grating or the volume holographic grating. The third diffraction grating area 33 is integrated or divided into the plurality of blocks, and a partition modulation mode of the third diffraction grating area 33 is the same as a partition modulation mode of the second diffraction grating area 32. That is, structural parameters of the third diffraction grating area 33 are the same as structural parameters of the second diffraction grating area 32. The third diffraction grating area 33 is able to reduce a total reflection step of the light beam in a waveguide substrate 10 while performing pupil expansion, thereby increasing a density of a field of view after pupil expansion to avoid light-pupil separation. Moreover, the coupled optical field achieves high color and illumination uniformity by adjusting diffraction efficiency of small blocks. A configuration of the third diffraction grating area 33 has an effect of increasing the density of the field of view after pupil expansion, and a maximum allowable thickness of the waveguide substrate 10 is increased on the premise of no light-pupil separation, such that a number of light splitting layers 41 of the coupling-out area 40 is reduced, thereby improving overall processibility of the optical waveguide structure.

In addition, the three diffraction grating areas are arranged in a form of diffraction gratings to turn light, such that the problem of process flow caused by multiple lamination required for turning of a geometric array is avoided, thereby improving processibility and mass production of the optical waveguide structure.

In an embodiment of the disclosure, the coupling-in area and the coupling-out area 40 are both geometric structures. Specifically, the coupling-in area includes one of a reflective surface 21 and a prism. When the coupling-in area includes the reflective surface 21, a side surface of the waveguide substrate 10 is obliquely arranged up and down, and the side surface is coated with a reflective film to form the reflective surface 21. A light beam is refracted into the waveguide substrate 10 from a surface of the waveguide substrate 10 making contact with air, and then is incident on the reflective surface 21, and the light beam is reflected by the reflective surface 21 or trapped in the waveguide substrate 10 by total reflection and continues propagating. When the coupling-in area includes the prism, the prism is a refracting prism, in particular a triple prism. One side surface of the triple prism is attached to a surface of the waveguide substrate 10, and light of an optical machine is guided into the waveguide substrate 10 by means of refraction of the triple prism, and is transmitted by total reflection in the waveguide substrate 10.

In an embodiment of the disclosure, when the coupling-in area includes the reflective surface 21, the reflective surface 21 is located at a side surface of the waveguide substrate 10, the waveguide substrate 10 has a first surface 11 and a second surface 12 arranged opposite each other, the reflective surface 21 is arranged at an obtuse angle relative to the first surface 11, the reflective surface 21 is arranged at an acute angle relative to the second surface 12, two sides of the reflective surface 21 are connected to the first surface 11 and the second surface 12 respectively, and an included angle θᵢₙ in between the reflective surface 21 and the second surface 12 satisfies:

$${θ}_{in} > 1 / 2 \cdot [ a sin ( sin {θ}_{H} / {n}_{wg} ) + a sin ( 1 / {n}_{wg} ) ] ;$$

wherein n_{wg} is a refractive index of the waveguide substrate 10, θ_{H}=atan[tan D_{θ}/\sqrt{1+1/k²}], D_{θ} is a field of view of an optical machine, and k is an aspect ratio of a projection screen of the optical machine. k>1.

In the embodiment, D_{θ} is actually a longitudinal field of view of the optical machine. θ_{H} is actually a transverse field of view of the optical machine. In this way, a reflection efficiency of the reflective surface 21 is ensured. It is ensured that a light beam is able to be coupled by means of geometric reflection of the reflective surface 21, and two-dimensional pupil expansion is achieved to avoid light leakage caused by diffraction coupling, such that high efficiency is able to be achieved; and θᵢₙ is combined with parameters of a material of the waveguide substrate 10 and the FOV to determine a range, thereby ensuring that the FOV of the incident light beam is able to be completely transmitted in the waveguide substrate 10 without an image defect.

With reference to FIGS. 2-15, the coupling-out area 40 includes a plurality of light splitting layers 41. The plurality of light splitting layers 41 are arrayed in the waveguide substrate 10, the plurality of light splitting layers 41 are located at one side of the diffraction grating area away from the coupling-in area, each of the plurality of light splitting layers 41 is obliquely arranged to the first surface 11 and the second surface 12, and any two adjacent light splitting layers 41 in the plurality of light splitting layers 41 are arranged parallel to each other. Each of the plurality of light splitting layers 41 is formed by laminating an angle-selective light splitting film layer and the waveguide substrate 10. In an embodiment, a number of the plurality of light splitting layers 41 is greater than or equal to 3 and less than or equal to 10; a reflectivity of each of the plurality of light splitting layers 41 is greater than 5% and less than or equal to 55%, a parallelism of each of the plurality of light splitting layers 41 is less than 6″, and an included angle between each of the plurality of light splitting layers 41 and the second surface 12 is equal to an included angle between the reflective surface 21 of the coupling-in area and the second surface 12, i.e. θₒᵤₜ=θᵢₙ; and the plurality of light splitting layers 41 perform the third pupil expansion on light beams turned by the second diffraction grating area 32 and the third diffraction grating area 33, such that the optical waveguide structure completes three two-dimensional pupil expansion and couples an optical field out. The coupling-out area 40 couples the light beam out by means of the light splitting layers 41 of an geometric array and achieves two-dimensional pupil expansion, thereby avoiding light leakage caused by diffraction coupling, and ensuring coupling-out efficiency and coupling-out uniformity.

The disclosure further provides an AR display device, the AR display device includes an optical machine and the optical waveguide structure. The optical machine is configured to emit image light to the optical waveguide structure. In an embodiment of the disclosure, the AR display device is AR glasses, and the optical machine is able to emit color light. The AR display device having the optical waveguide structure is able to have the advantages of no dispersion, high efficiency and high color uniformity.

The optical waveguide structure of the disclosure will be described below with reference to the specific embodiments and accompanying drawings.

### Embodiment 1

As shown in FIGS. 1-15, an optical waveguide structure of Embodiment 1 is described.

FIG. 1 shows a k-domain diagram of the optical waveguide structure of the embodiment. A condition that light is able to be completely transmitted in the waveguide substrate 10 is that a field of view of the light is able to satisfy a k-domain closed loop. As shown in FIG. 1, an optical field emitted by an optical machine is reflected in the k-domain diagram as a rectangular area k-in of main light perpendicular to a Z axis, i.e. a rectangular array area formed by a plurality of red dots in a center. A vector k after passing through the reflective surface 21 is k-reflect in a vector direction of a black solid arrow, i.e. a rectangular array area formed by a plurality of blue dots on a right side, and a vector k-r of the reflective surface 21 is decided by θᵢₙ and an azimuth angle φ, k−r=(sin θᵢₙ, cos φ, sin θᵢₙ, sinφ, cos φ). An obliquely downward black solid arrow is a vector direction of the first diffraction grating area 31, and a k-domain after passing through the first diffraction grating area 31 is k-g. k-g includes k-g (b), k-g (g), k-g (r). Thus, a rectangular red lattice, a rectangular green lattice and a rectangular blue lattice are formed below. Vector directions of the second diffraction grating area 32 and the third diffraction grating area 33 are an obliquely upward dashed line direction. A k-domain after passing through the second diffraction grating area 32 and the third diffraction grating area 33 is k-g back, i.e. a rectangular array formed by a plurality of pinkish-purple circles. A rectangular array formed by the plurality of pinkish-purple circles coincides with k-reflect, a leftward black dashed line arrow is a vector direction of the coupling-out area 40, the k-domain after passing through the coupling-out area 40 is k-out, i.e. a rectangular array formed by a plurality of red circles in a center, and the rectangular array formed by the plurality of red circles coincides with k-in, thus forming the k-domain closed loop. After k-in is coupled into the waveguide substrate 10, k-in passes through vector transformation of the first diffraction grating area 31, the second diffraction grating area 32 and the coupling-out area 40, and finally k-out having the same size and an opposite direction couples the waveguide substrate 10 out to form closed loop in the k-domain diagram. In the process, transformation of the FOV also satisfies the conditions of waveguide transmission, and a complete FOV is able to be transmitted out. It is seen from the figure that grating vectors of the first diffraction grating area 31, the second diffraction grating area 32 and the third diffraction grating area 33 on the k-domain diagram are equal in magnitude, and the grating vector direction of the first diffraction grating area 31 is opposite to the grating vector direction of the second diffraction grating area 32. That is, the grating vector directions of the first diffraction grating area 31, the second diffraction grating area 32 and the third diffraction grating area 33 on the k-domain diagram are all arranged in parallel.

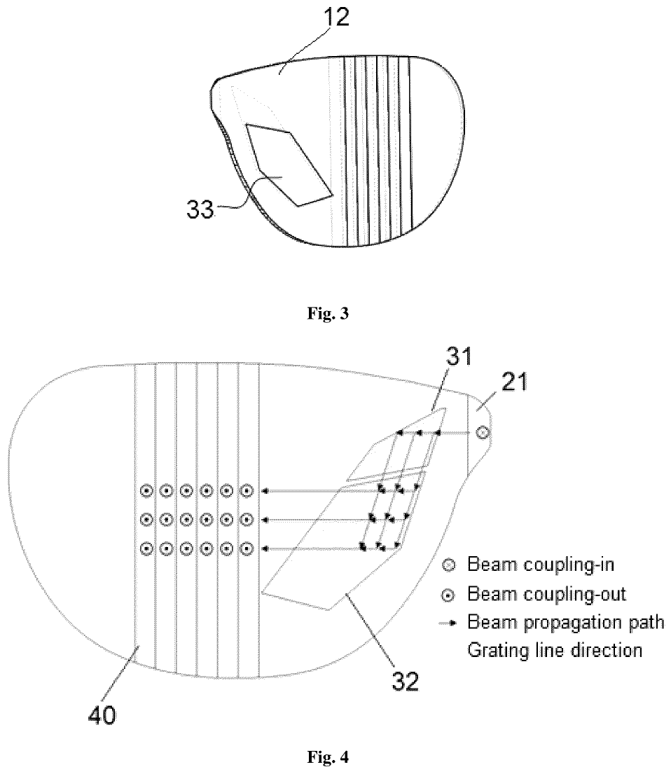

FIGS. 2-3 show schematic diagrams of two side surfaces of the optical waveguide structure of the embodiment. FIG. 4 shows an optical path diagram of the optical waveguide structure of the embodiment. In the embodiment, the coupling-in area is the reflective surface 21 coated with a film, and the coupling-out area 40 includes a plurality of light splitting layers 41 arranged in parallel, specifically six light splitting layers 41. The first diffraction grating area 31 and the second diffraction grating area 32 are arranged on the first surface 11 of the waveguide substrate 10 in a spaced manner and are located between the coupling-in area and the coupling-out area 40. The first diffraction grating area 31 and the second diffraction grating area 32 are arranged at an acute angle or an obtuse angle relative to the light splitting layers 41. The third diffraction grating area 33 is located on the second surface 12 of the waveguide substrate 10 and corresponds to the second diffraction grating area 32, and the projection area of the second diffraction grating area 32 on the waveguide substrate 10 completely coincides with and is equal to the projection area of the third diffraction grating on the waveguide substrate 10.

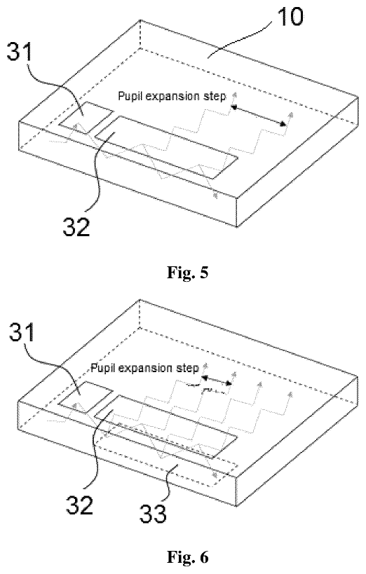

As shown in FIGS. 5-6, no third diffraction grating area 33 is arranged in FIG. 5, and the third diffraction grating area 33 is arranged in FIG. 6. It is seen from the figure that the third diffraction grating area 33 is additionally arranged, such that a total reflection step of the light in the waveguide substrate 10 is reduced, thereby increasing a density of a field of view after pupil expansion to avoid light-pupil separation, further improving diffraction efficiency, and improving color uniformity and illumination uniformity of a coupled image.

As shown in FIGS. 12-15, the longitudinal field of view De of the optical machine is 30°, an included angle θᵢₙ between the reflective surface 21 and the second surface 12 is 25.7°, an azimuth angle φ of the reflective surface 21 is 0°, a refractive index n_{wg} of the waveguide substrate 10 is 1.64, an included angle θ_{colck} between a grating vector direction of any one of the first diffraction grating area 31, the second diffraction grating area 32 and the third diffraction grating area 33 on the k-domain diagram and a y-axis is 120°, and a grating period of any one of the first diffraction grating area 31, the second diffraction grating area 32 and the third diffraction grating area 33 is the same, and is d=420 mm, and an included angle θₒᵤₜ between each of the plurality of light splitting layers 41 and the second surface 12 is 25.7°. Each of the plurality of light splitting layers 41 is coated with a light splitting film, and reflectivity of the six light splitting layers 41 in a direction away from the diffraction grating areas is r₁=10%, r₂=11.1%, r₃=12.5%, r₄=14.28%, r₅=16.67% and r₆=20% respectively.

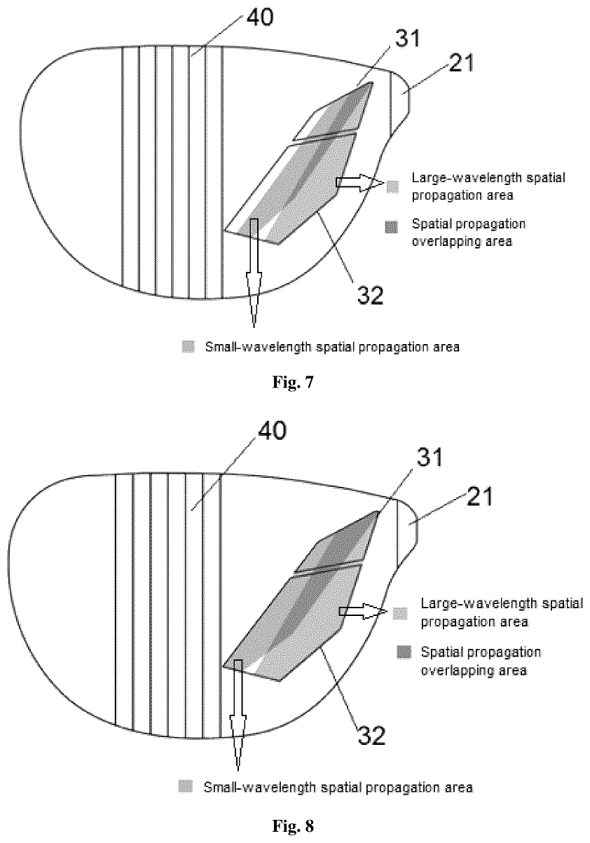

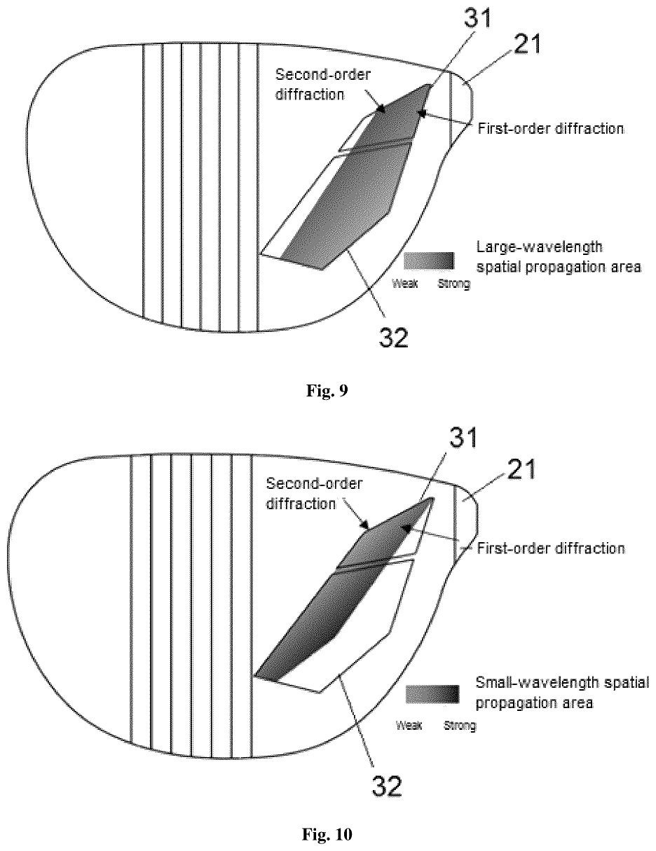

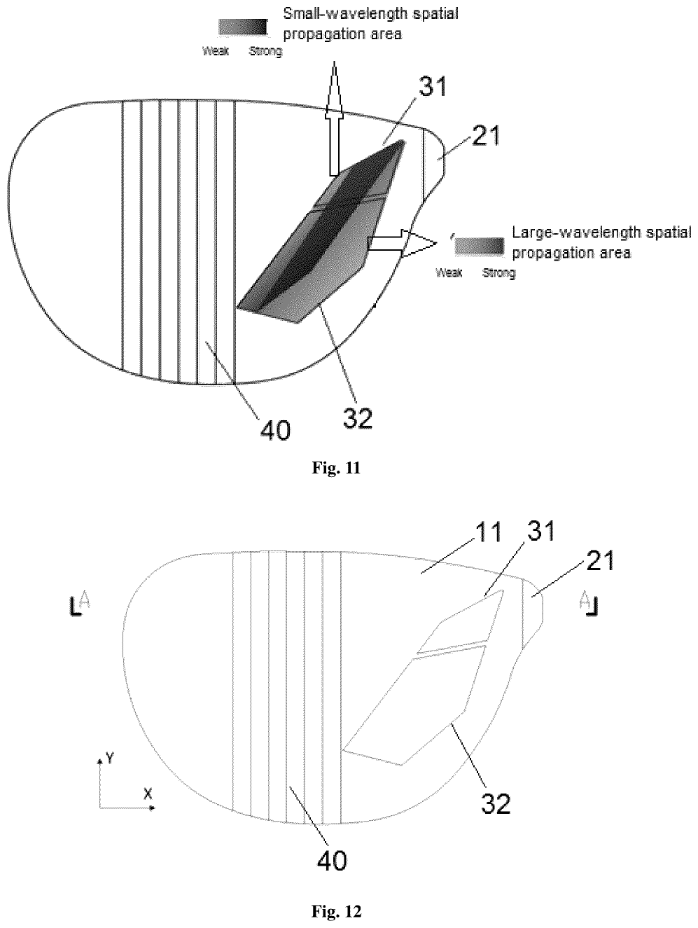

As shown in FIGS. 7-11, the first diffraction grating area 31 is integrated, and the first diffraction grating area 31 has a vector height of 55.8 um and a duty ratio of 66.25%; and duty ratios of the second diffraction grating area 32 and the third diffraction grating area 33 are the same as the duty ratio of the first diffraction grating area 31, the second diffraction grating area 32 is divided into a plurality of blocks, the duty ratio of each of the plurality of blocks is 66.25%, and the vector heights of different blocks are different. Specifically, the vector heights of the plurality of blocks are gradually increased in a direction away from the second diffraction grating area 32, and are gradually increased from 66.32 um to 145.95 um in a direction away from the second diffraction grating area 32. The third diffraction grating area 33 is the same as the second diffraction grating area 32. Thus, a diffraction efficiency of different orders of blocks is modulated, and illumination and color uniformity of the coupled optical field are modulated, such that the color uniformity of the coupled optical field is better, and spatial propagation areas of large-wavelength light and small-wavelength light are planned to ensure stability of diffraction transmission. FIG. 7 shows a schematic diagram of path energy coincidence after light the first diffraction grating area 31 performing the first-order diffraction on the light. It is seen from the figure that a large and small wavelength spatial propagation overlapping area is small. FIG. 8 shows a schematic diagram of path energy coincidence after the first diffraction grating area 31 performing the second-order diffraction on the light. It is seen from the figure that a large and small wavelength spatial propagation overlapping area is increased. As shown in FIGS. 9-10, efficiency distribution of two diffraction of large and small wavelengths is regulated by regulating the duty ratio and the vector height of the first diffraction grating area 31, thus, FIG. 11 is obtained. It is seen from FIG. 11 that an energy proportion of a large and small wavelength spatial propagation overlapping area is increased.

### Embodiment 2

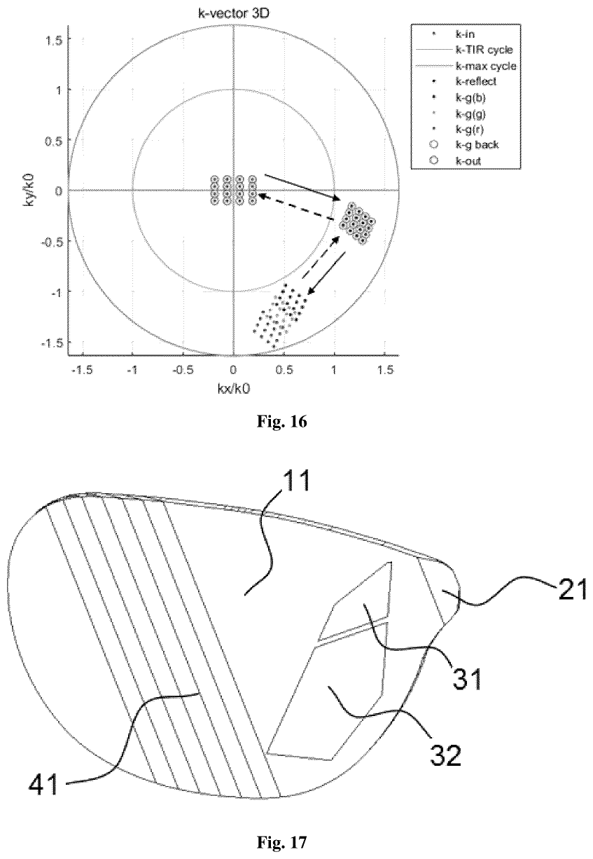

As shown in FIGS. 16-17, an optical waveguide structure of Embodiment 2 is described.

FIG. 16 shows a k-domain diagram of the optical waveguide structure of the embodiment. For explanation of the k-domain diagram, reference is made to description of Embodiment 1. FIG. 17 shows a schematic structural diagram of the optical waveguide structure of the embodiment. In the embodiment, the azimuth angle φ of the reflective surface 21 is 15°, the included angle θ_{colck} between the grating vector direction of any one of the first diffraction grating area 31, the second diffraction grating area 32, and the third diffraction grating area 33 on the k-domain diagram and the y-axis is 130°, the grating period of any one of the first diffraction grating area 31, the second diffraction grating area 32, and the third diffraction grating area 33 is the same and is d=450 mm, and remaining parameters are the same as those of Embodiment 1.

As shown in FIG. 17, both the reflective surface 21 and the light splitting layer 41 are inclined by an angle to some extent compared with Embodiment 1, such that a light beam obtains an additional y-direction component when reflected by the reflective surface 21. Thus, a range of a field of view in a k-domain is not rectangular, but rotates to approach a diamond. In the configuration, a grating period is reduced, and dispersion of light beams of different wavelengths is correspondingly reduced, thereby improving color uniformity of a finally coupled optical field.

### Embodiment 3

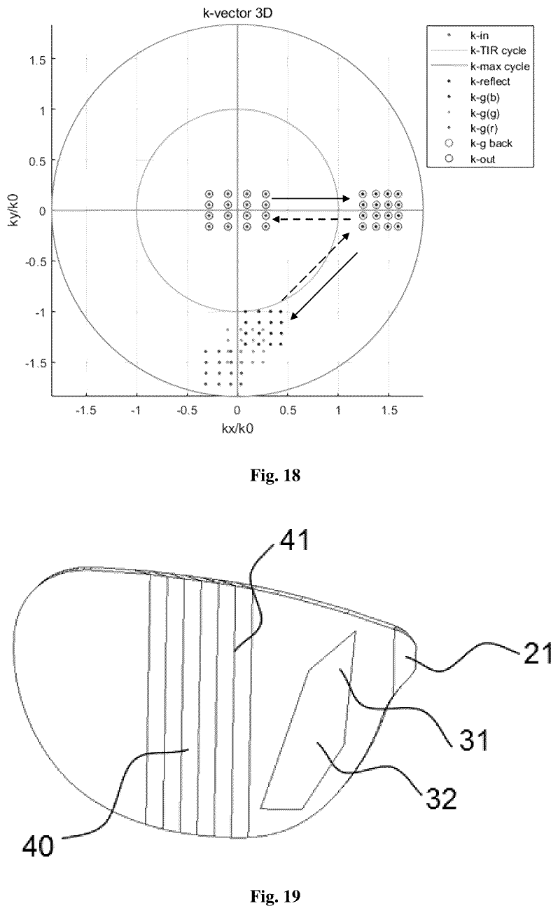

As shown in FIGS. 18-20, an optical waveguide structure of Embodiment 3 is described.

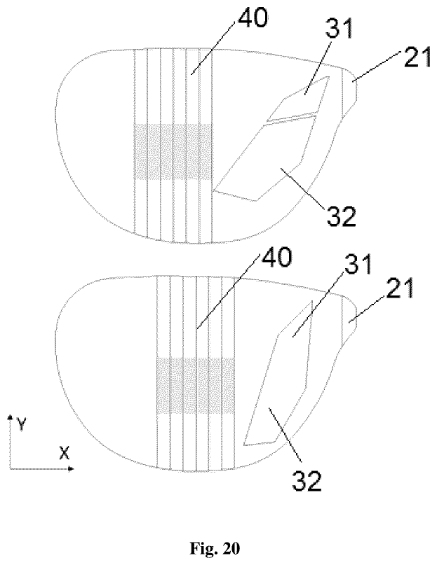

FIG. 18 shows a k-domain diagram of the optical waveguide structure of the embodiment. For explanation of the k-domain diagram, reference is made to description of Embodiment 1. FIG. 19 shows a schematic structural diagram of the optical waveguide structure of the embodiment. FIG. 20 shows a comparison diagram of optical waveguide structures of the embodiment and Embodiment 1.

In the embodiment, the longitudinal field of view D_{θ} of an optical machine is 40°, the included angle θᵢₙ between the reflective surface 21 and the second surface 12 is 25.7°, the azimuth angle φ of the reflective surface 21 is 0°, the refractive index n_{wg} of a waveguide substrate 10 is 1.84, the included angle θ_{colck} between the grating vector direction of any one of the first diffraction grating area 31, the second diffraction grating area 32 and the third diffraction grating area 33 on the k-domain diagram and the y-axis is 135°, and the grating period of any one of the first diffraction grating area 31, the second diffraction grating area 32 and the third diffraction grating area 33 is the same, and is d=280 mm, the included angle θₒᵤₜ between each of light splitting layers 41 and the second surface 12 is 25.7°. Each of the plurality of light splitting layers 41 is coated with a light splitting film, and reflectivity of the six light splitting layers 41 in a direction away from a diffraction grating area is r₁=r₂=11.45%, r₃=r₄=14.28%, and r₅=r₆=22% respectively. When only three sets of film systems are used for the six light splitting layers 41 of the embodiment, coupling-out uniformity is slightly reduced, but the number of film systems is reduced, thereby reducing cost of the film systems. Moreover, due to reduction of the number of the film systems, materials are easier to control, and process control is also simplified, thereby improving mass production of the optical waveguide structure.

As shown in FIG. 18, in the k-domain diagram, a y-direction component of a propagation direction of an angle of a light beam through the first diffraction grating area 31 is large, and is close to vertically downward. Thus, a propagation distance of the light beam in an x-direction is short. Compared with Embodiment 1, structure layout on the waveguide substrate 10 is more compact in a transverse direction, thereby being more advantageous in products having smaller widths of the waveguide substrate 10.

As shown in FIGS. 19-20, the first diffraction grating area 31 and the second diffraction grating area 32 of the embodiment are continuously arranged. That is, the first diffraction grating area 31 and the second diffraction grating area 32 are arranged without an interval. In this way, an appearance of the optical waveguide structure of the embodiment is more beautiful than that of Embodiment 1.

Apparently, the embodiments described above are merely some embodiments rather than all embodiments of the disclosure. On the basis of the embodiments of the disclosure, all other embodiments obtained by those of ordinary skill in the art without making inventive efforts should all fall within the scope of protection of the disclosure.

It should be noted that the terms used herein are merely for describing the particular embodiments and are not intended to limit the exemplary embodiments according to the disclosure. As used herein, the singular is also intended to include the plural unless the context clearly dictates, and furthermore, it should be understood that the terms “include” and/or “comprise”, when used in the description, specify the presence of features, steps, operations, devices, components, and/or their combinations.

It should be noted that the terms “first”, “second”, etc. in the description and claims of the disclosure and in the accompanying drawings described above, are used to distinguish similar objects, and not necessarily to describe a particular order or sequential order. It should be understood that the data used in this way can be interchanged where appropriate, such that the embodiments of the disclosure described herein can be implemented in other sequences than those illustrated or described herein.

What are described above is merely specific embodiments of the disclosure and are not intended to limit the disclosure, and for those skilled in the art, the disclosure can be variously modified and changed. Any modifications, equivalent substitutions, improvements, etc. within the spirit and principles of the disclosure are intended to fall within the scope of protection of the disclosure.

What is claimed is:

1. An optical waveguide structure, comprising:
a waveguide substrate;
a coupling-in area, wherein the coupling-in area is arranged on the waveguide substrate;
a diffraction grating area, wherein a plurality of diffraction grating areas are provided, two side surfaces of the waveguide substrate are provided with the diffraction grating area, and a number of the diffraction grating area on at least one side surface of the waveguide substrate is greater than or equal to 2, periods of the plurality of diffraction grating areas are equal, and the plurality of diffraction grating areas are configured to perform multiple pupil expansions on a light; and
a coupling-out area, wherein the coupling-out area is arranged on the waveguide substrate, the plurality of diffraction grating areas are all located between the coupling-in area and the coupling-out area, and the coupling-out area is configured to perform pupil expansion transmission on a light in the waveguide substrate and emit the light.

2. The optical waveguide structure according to claim 1, wherein:
the plurality of diffraction grating areas comprise a first diffraction grating area, a second diffraction grating area and a third diffraction grating area, the first diffraction grating area and the second diffraction grating area are located on one side surface of the waveguide substrate, the third diffraction grating area is located on the other side surface of the waveguide substrate, the first diffraction grating area is configured to receive a light of the coupling-in area and perform a first pupil expansion, and the second diffraction grating area and the third diffraction grating area are configured to receive a light of the first diffraction grating area and perform a second pupil expansion.

3. The optical waveguide structure according to claim 2, wherein:
the first diffraction grating area and the second diffraction grating area are arranged continuously or arranged in a spaced manner, the second diffraction grating area is the same as the third diffraction grating area, and a projection of the second diffraction grating area on the waveguide substrate at least partially coincides with a projection of the third diffraction grating area on the waveguide substrate; and/or
the first diffraction grating area performs the first pupil expansion on the light, the second diffraction grating area performs the second pupil expansion on the light, the third diffraction grating area performs a third pupil expansion on the light, a pupil expansion propagation direction of the light on the first diffraction grating area is the same as a pupil expansion propagation direction of the light on the third diffraction grating area, and the pupil expansion propagation direction of the light on the first diffraction grating area is different from a pupil expansion propagation direction of the light on the second diffraction grating area.

4. The optical waveguide structure according to claim 2, wherein:
periods of the first diffraction grating area, the second diffraction grating area and the third diffraction grating area are equal; and/or
included angles between grating vector directions of the first diffraction grating area, the second diffraction grating area and the third diffraction grating area on a k-domain diagram and a y-axis are equal.

5. The optical waveguide structure according to claim 2, wherein:
grating vectors of the first diffraction grating area, the second diffraction grating area and the third diffraction grating area are equal in magnitude; and/or
a grating vector direction of the second diffraction grating area is the same as a grating vector direction of the third diffraction grating area, and a grating vector direction of the first diffraction grating area is opposite to the grating vector direction of the second diffraction grating area.

6. The optical waveguide structure according to claim 2, wherein:
a 0th-order diffraction efficiency R₀ of the first diffraction grating area satisfies: 5%<R₀<60%, and a +1st-order or −1st-order diffraction efficiency R₁ of the first diffraction grating area satisfies: 40%<R₁<95%; and/or
a 0th-order diffraction efficiency R₀ of the second diffraction grating area satisfies: 10%<R₀<95%, and a +1st-order or −1st-order diffraction efficiency R₁ of the second diffraction grating area satisfies: 5%<R₁<80%.

7. The optical waveguide structure according to claim 2, wherein:
at least one of the first diffraction grating area, the second diffraction grating area and the third diffraction grating area is divided into a plurality of blocks, at least one of a vector height and a duty ratio of each of the plurality of blocks is regularly changed, and when one of the vector height and the duty ratio is regularly changed, the other one of the vector height and the duty ratio is a fixed value.

8. The optical waveguide structure according to claim 1, wherein:
the plurality of diffraction grating areas comprise one or more of surface relief gratings and volume holographic gratings.

9. The optical waveguide structure according to claim 1, wherein:
the coupling-in area comprises one of a reflective surface and a prism, when the coupling-in area comprises the reflective surface, the reflective surface is located at a side surface of the waveguide substrate, the waveguide substrate has a first surface and a second surface arranged opposite each other, the reflective surface is arranged at an acute angle relative to one of the first surface and the second surface, and an included angle θᵢₙ between the reflective surface and the first surface or the second surface satisfies:
$${θ}_{in} > 1 / 2 \cdot [ a sin ( sin {θ}_{H} / {n}_{wg} ) + a sin ( 1 / {n}_{wg} ) ] ;$$
wherein n_{wg} is a refractive index of the waveguide substrate, θ_{H}=atan[tan D_{θ}/\sqrt{1+1/k²}], D_{θ} is a field of view of an optical machine, and k is an aspect ratio of a projection screen of the optical machine.

10. The optical waveguide structure according to claim 1, wherein:
the coupling-out area comprises a plurality of light splitting layers, the plurality of light splitting layers are arrayed in the waveguide substrate, the plurality of light splitting layers are located at one side of the diffraction grating area away from the coupling-in area, the waveguide substrate has a first surface and a second surface arranged opposite each other, and each of the plurality of light splitting layers is obliquely arranged to the first surface and the second surface, and
a number of the plurality of light splitting layers is greater than or equal to 3 and less than or equal to 10; and/or
a reflectivity of each of the plurality of light splitting layers is greater than 5% and less than or equal to 55%; and/or
an included angle between each of the plurality of light splitting layers and the second surface is equal to an included angle between a reflective surface of the coupling-in area and the second surface.

11. An AR display device, comprising:
an optical machine; and
the optical waveguide structure according to claim 1, wherein the optical machine is configured to emit image light to the optical waveguide structure.

12. The AR display device according to claim 11, wherein:
the plurality of diffraction grating areas comprise a first diffraction grating area, a second diffraction grating area and a third diffraction grating area, the first diffraction grating area and the second diffraction grating area are located on one side surface of the waveguide substrate, the third diffraction grating area is located on the other side surface of the waveguide substrate, the first diffraction grating area is configured to receive a light of the coupling-in area and perform a first pupil expansion, and the second diffraction grating area and the third diffraction grating area are configured to receive a light of the first diffraction grating area and perform a second pupil expansion.

13. The AR display device according to claim 12, wherein:
the first diffraction grating area and the second diffraction grating area are arranged continuously or arranged in a spaced manner, the second diffraction grating area is the same as the third diffraction grating area, and a projection of the second diffraction grating area on the waveguide substrate at least partially coincides with a projection of the third diffraction grating area on the waveguide substrate; and/or
the first diffraction grating area performs the first pupil expansion on the light, the second diffraction grating area performs the second pupil expansion on the light, the third diffraction grating area performs a third pupil expansion on the light, a pupil expansion propagation direction of the light on the first diffraction grating area is the same as a pupil expansion propagation direction of the light on the third diffraction grating area, and the pupil expansion propagation direction of the light on the first diffraction grating area is different from a pupil expansion propagation direction of the light on the second diffraction grating area.

14. The AR display device according to claim 12, wherein:
periods of the first diffraction grating area, the second diffraction grating area and the third diffraction grating area are equal; and/or
included angles between grating vector directions of the first diffraction grating area, the second diffraction grating area and the third diffraction grating area on a k-domain diagram and a y-axis are equal.

15. The AR display device according to claim 12, wherein:
grating vectors of the first diffraction grating area, the second diffraction grating area and the third diffraction grating area are equal in magnitude; and/or
a grating vector direction of the second diffraction grating area is the same as a grating vector direction of the third diffraction grating area, and a grating vector direction of the first diffraction grating area is opposite to the grating vector direction of the second diffraction grating area.

16. The AR display device according to claim 12, wherein:
a 0th-order diffraction efficiency R₀ of the first diffraction grating area satisfies: 5%<R₀<60%, and a +1st-order or −1st-order diffraction efficiency R₁ of the first diffraction grating area satisfies: 40%<R₁<95%; and/or
a 0th-order diffraction efficiency R₀ of the second diffraction grating area satisfies: 10%<R₀<95%, and a +1st-order or −1st-order diffraction efficiency R₁ of the second diffraction grating area satisfies: 5%<R₁<80%.

17. The AR display device according to claim 12, wherein:
at least one of the first diffraction grating area, the second diffraction grating area and the third diffraction grating area is divided into a plurality of blocks, at least one of a vector height and a duty ratio of each of the plurality of blocks is regularly changed, and when one of the vector height and the duty ratio is regularly changed, the other one of the vector height and the duty ratio is a fixed value.

18. The AR display device according to claim 11, wherein:
the plurality of diffraction grating areas comprise one or more of surface relief gratings and volume holographic gratings.

19. The AR display device according to claim 11, wherein:
the coupling-in area comprises one of a reflective surface and a prism, when the coupling-in area comprises the reflective surface, the reflective surface is located at a side surface of the waveguide substrate, the waveguide substrate has a first surface and a second surface arranged opposite each other, the reflective surface is arranged at an acute angle relative to one of the first surface and the second surface, and an included angle θᵢₙ between the reflective surface and the first surface or the second surface satisfies:
$${θ}_{in} > 1 / 2 \cdot [ a sin ( sin {θ}_{H} / {n}_{wg} ) + a sin ( 1 / {n}_{wg} ) ] ;$$
wherein n_{wg} is a refractive index of the waveguide substrate, θ_{H}=atan[tan D_{θ}/\sqrt{1+1/k²}], D_{θ} is a field of view of an optical machine, and k is an aspect ratio of a projection screen of the optical machine.

20. The AR display device according to claim 11, wherein:
the coupling-out area comprises a plurality of light splitting layers, the plurality of light splitting layers are arrayed in the waveguide substrate, the plurality of light splitting layers are located at one side of the diffraction grating area away from the coupling-in area, the waveguide substrate has a first surface and a second surface arranged opposite each other, and each of the plurality of light splitting layers is obliquely arranged to the first surface and the second surface, and
a number of the plurality of light splitting layers is greater than or equal to 3 and less than or equal to 10; and/or
a reflectivity of each of the plurality of light splitting layers is greater than 5% and less than or equal to 55%; and/or
an included angle between each of the plurality of light splitting layers and the second surface is equal to an included angle between a reflective surface of the coupling-in area and the second surface.
